(19) United States
(12) Patent Application Publication
(10) Pub. No.: US 2025/0252547 A1
(43) Pub. Date: Aug. 7, 2025

(54) CORROSION POSITIONING SYSTEM, CORROSION INSPECTION VEHICLE AND CORROSION POSITIONING METHOD USING THE SAME

(71) Applicant: INDUSTRIAL TECHNOLOGY RESEARCH INSTITUTE, Hsinchu (TW)

(72) Inventors: Cheng-Yang TSAI, Taoyuan City (TW); Yuan-Heng SUN, New Taipei City (TW); Ming-Yuan HO, Minxiong Township (TW); Ting-Wei HUANG, Yilan City (TW)

(73) Assignee: INDUSTRIAL TECHNOLOGY RESEARCH INSTITUTE, Hsinchu (TW)

(21) Appl. No.: 18/735,368

(22) Filed: Jun. 6, 2024

(30) Foreign Application Priority Data
Feb. 1, 2024 (TW) 113104042

(51) Int. Cl. G06T 7/00; G01S 17/89; G05D 1/60; G05D 101/15; G05D 105/80; G05D 111/10

(52) U.S. Cl. CPC G06T 7/0004; G01S 17/89; G05D 1/60; G05D 2101/15; G05D 2105/89; G05D 2111/17; G06T 2207/20084; G06T 2207/30136; G06T 2207/30152; G06T 2207/30252

(57) ABSTRACT

A corrosion positioning system, a corrosion inspection vehicle and a corrosion positioning method using the same are provided. The corrosion positioning method includes the following steps. An image information is read by a corrosion hotspot recognition module to recognize a corrosion hotspot. A location information of the corrosion hotspot is obtained by a corrosion hotspot positioning module. The location information of the corrosion hotspot is corrected by an inspection optimization module to obtain a corrected location information. The step of correcting the location information of the corrosion hotspot includes the following steps. The correlation information of a plurality of feature points in a plurality of frames in the image information is analyzed by the inspection optimization module. The position information of a point to be corrected is corrected by the inspection optimization module according to the correlation information. The location information is normalized by the inspection optimization module.

This application claims the benefit of Taiwan application Serial No. 113104042, filed Feb. 1, 2024, the disclosure of which is incorporated by reference herein in its entirety.

### TECHNICAL FIELD

The disclosure relates to a corrosion positioning system, a corrosion inspection vehicle and a corrosion positioning method using the same.

### BACKGROUND

The equipment in an industrial factory may be large-scale and the pipelines may be quite complex. Since pipelines are usually exposed outdoors, they are prone to various types of corrosion. Traditionally, it is necessary to rely on manual inspections to detect corrosion and repair it. This method is quite labor-intensive and time-consuming, and it is easy to miss undiscovered corrosion areas due to visual inspection. Therefore, how to effectively improve the inspection efficiency for corrosion areas, save manpower inspection time and reduce omissions has become the direction of research and development in the industry.

### SUMMARY

The disclosure is directed to a corrosion positioning system, a corrosion inspection vehicle and a corrosion positioning method using the same. The image recognition technology is used to recognize a corrosion hotspot area, and a location information of the corrosion hotspot area is obtained through the positioning technology. In addition, the location information of the corrosion hotspot area could be corrected using the optimization technology to improve the accuracy of inspection and positioning of the corrosion hotspot area.

According to one embodiment, a corrosion positioning method is provided. The corrosion positioning method is adopted to be built in program codes to be executed by a computer to perform the following steps, including: reading, by a corrosion hotspot recognition module, an image information, to recognize a corrosion hotspot area; obtaining, by a corrosion hotspot positioning module, a location information of the corrosion hotspot area; and correcting, by an inspection optimization module, the location information of the corrosion hotspot area, to obtain a corrected location information. The step of correcting the location information of the corrosion hotspot area includes: analyzing, by the inspection optimization module, a correlation information of a plurality of feature points in a plurality of frames in the image information; correcting, by the inspection optimization module, the location information of a point to be corrected according to the correlation information; and normalizing, by the inspection optimization module, the location information, to obtain a corrected location information.

According to another embodiment, a corrosion positioning system is provided. The corrosion positioning system is adopted to be built as a computer. The corrosion positioning system includes a corrosion hotspot recognition module, a corrosion hotspot positioning module and an inspection optimization module. The corrosion hotspot recognition module is used to read an image information to recognize a corrosion hotspot area. The corrosion hotspot positioning module is used to obtain a location information of the corrosion hotspot area. The inspection optimization module is used to correct the location information of the corrosion hotspot area to obtain the corrected location information. The inspection optimization module includes a correlation analysis unit, a correction unit and a normalization unit. The correlation analysis unit is used to analyze a correlation information of a plurality of feature points in a plurality of frames in the image information. The correction unit is used to correct the location information of a point to be corrected according to the correlation information. The normalization unit is used to normalize the location information to obtain a corrected location information.

According to an alternative embodiment, a corrosion inspection vehicle is provided. The corrosion inspection vehicle includes a moving platform, an image capturing device, a lidar positioning device and a corrosion positioning system. The image capturing device is disposed on the moving platform. The image capturing device is used to capture an image information. The lidar positioning device is disposed on the moving platform. The corrosion positioning system is disposed on the moving platform. The corrosion positioning system includes a corrosion hotspot recognition module, a corrosion hotspot positioning module and an inspection optimization module. The corrosion hotspot recognition module is used to read the image information to recognize a corrosion hotspot area. The corrosion hotspot positioning module is used to obtain a location information of the corrosion hotspot area. The inspection optimization module is used to correct the location information of the corrosion hotspot area to obtain the corrected location information. The inspection optimization module includes a correlation analysis unit, a correction unit and a normalization unit. The correlation analysis unit is used to analyze a correlation information of a plurality of feature points in a plurality of frames in the image information. The correction unit is used to correct the location information of a point to be corrected according to the correlation information. The normalization unit is used to normalize the location information to obtain a corrected location information.

### BRIEF DESCRIPTION OF THE DRAWINGS

FIG. 1A and FIG. 1B respectively illustrate schematic diagrams of inspection and positioning of corrosion areas according to an embodiment of the present disclosure.

FIG. 2 illustrates a corrosion inspection vehicle according to an embodiment of the present disclosure.

FIG. 3 illustrates a block diagram of the corrosion inspection vehicle and the corrosion positioning system thereof according to an embodiment of the present disclosure.

FIG. 4 illustrates a flow chart of a corrosion positioning method according to an embodiment of the present disclosure.

FIG. 5A illustrates a detailed flow chart of the step S152 according to an embodiment of the present disclosure.

FIG. 5B illustrates the steps in FIG. 5A.

FIG. 6 illustrates the mutual nearest neighbor algorithm.

FIG. 7 illustrates the matching of the feature points in these images.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

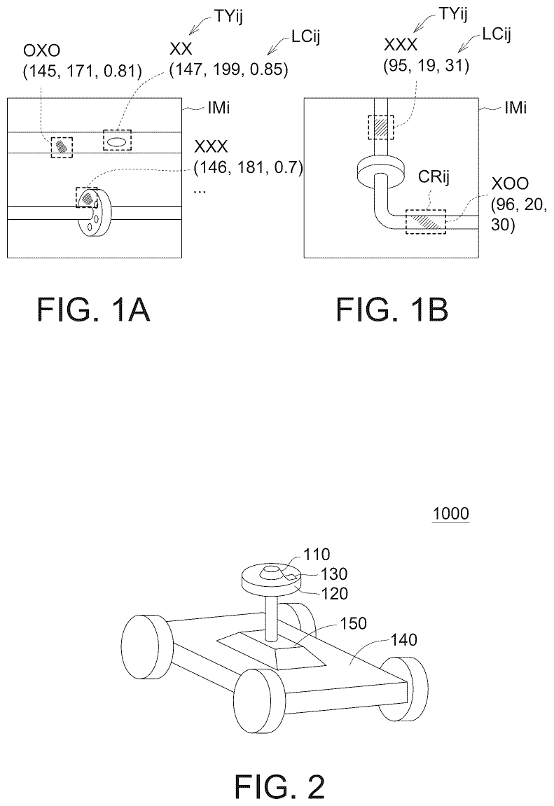

Please refer to FIG. 1A and FIG. 1B, which respectively illustrate schematic diagrams of inspection and positioning of corrosion areas according to an embodiment of the present disclosure. In this embodiment, an image capturing device could be used to capture a plurality of image information IMi for the pipeline during the inspection process, and then the image information IMi could be used to detect at least one corrosion hotspot area CRij on these pipelines and at least one corrosion hotspot type TYij thereof, and obtain a location information LCij of the corrosion hotspot area CRij. The method of this embodiment does not consume too much manpower and time, and all corrosion could be detected. The efficiency and the accuracy of inspection and positioning of the corrosion areas could be effectively improved.

Please refer to FIG. 2, which illustrates a corrosion inspection vehicle 1000 according to an embodiment of the present disclosure. The corrosion inspection vehicle 1000 includes a moving platform 140, an image capturing device 110, a lidar positioning device 120, an inertial sensing device 130 and a corrosion positioning system 150. The image capturing device 110, the lidar positioning device 120, the inertial sensing device 130 and the corrosion positioning system 150 are disposed on the moving platform 140. The image capturing device 110 is used to capture the image information IMi. The image capturing device 110 may be a fixed (or rotatable) video camera, or camera. The inertial sensing device 130 is, for example, a 6-axis gyroscope, a 9-axis gyroscope or an accelerometer. The corrosion positioning system 150 is, for example, a server, local or remote, a computer, or a circuit board, which has a processor and a storage device that stores program codes to be executed by the processor to perform a serial of steps of a corrosion positioning method.

In another embodiment, the image capturing device 110, the lidar positioning device 120, the inertial sensing device 130 and the corrosion positioning system 150 could be disposed on a backpack or a backrest, and the personnel could carry the backpack or the backrest through the factory to conduct inspections.

In this embodiment, the corrosion inspection vehicle 1000 could continuously capture the image information IMi using the image capturing device 110 while traveling, and obtain the location information in real time through the lidar positioning device 120 and the inertial sensing device 130. Once the corrosion hotspot area CRij (marked in FIG. 1B) is recognized from the captured image information IMi, the location information LCij (marked in FIG. 1A, FIG. 1B) of the corrosion hotspot area CRij could be obtained.

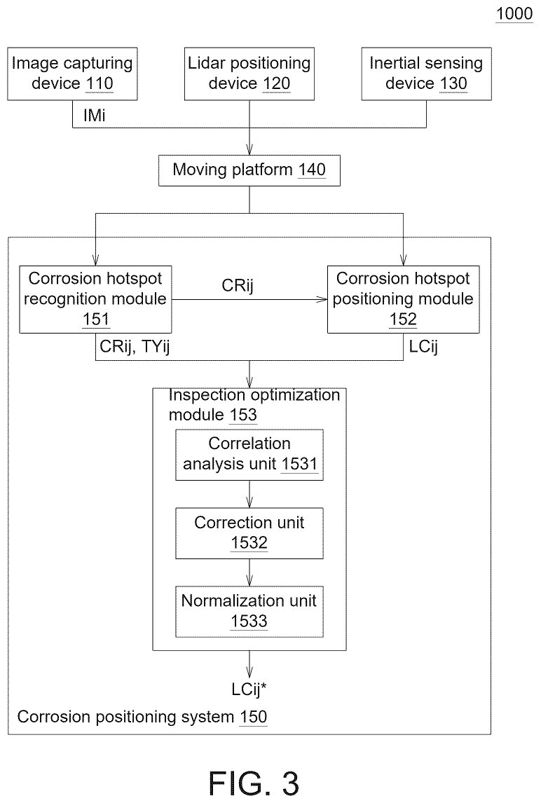

Please refer to FIG. 3, which illustrates a block diagram of the corrosion inspection vehicle 1000 and the corrosion positioning system 150 thereof according to an embodiment of the present disclosure. The corrosion positioning system 150 includes a corrosion hotspot recognition module 151, a corrosion hotspot positioning module 152 and an inspection optimization module 153. The corrosion hotspot recognition module 151 is used for performing an image recognition procedure. The corrosion hotspot positioning module 152 is used for performing a positioning procedure. The inspection optimization module 153 is used for performing a calibration procedure. The corrosion hotspot recognition module 151, the corrosion hotspot positioning module 152 and/or the inspection optimization module 153 is, for example, a circuit or a chip of a computer, or a part of the program codes.

The inspection optimization module 153 includes a correlation analysis unit 1531, a correction unit 1532 and a normalization unit 1533. The correlation analysis unit 1531 is used to analyze correlation. The correction unit 1532 is used to correct the image position information. The normalization unit 1533 is used to perform a normalization procedure. The correlation analysis unit 1531, the correction unit 1532 and/or the normalization unit 1533 is, for example, a circuit or a chip of a hardware module, or a part of program codes of a software module.

In this embodiment, after the corrosion hotspot recognition module 151 recognizes the corrosion hotspot area CRij from the image information IMi, the corrosion hotspot positioning module 152 obtains the location information LCij of the corrosion hotspot area CRij. Then, the inspection optimization module 153 performs correction and optimization on the location information LCij to obtain a more accurate corrosion location. The following is a detailed description of the operation of each of the above components with a flow chart.

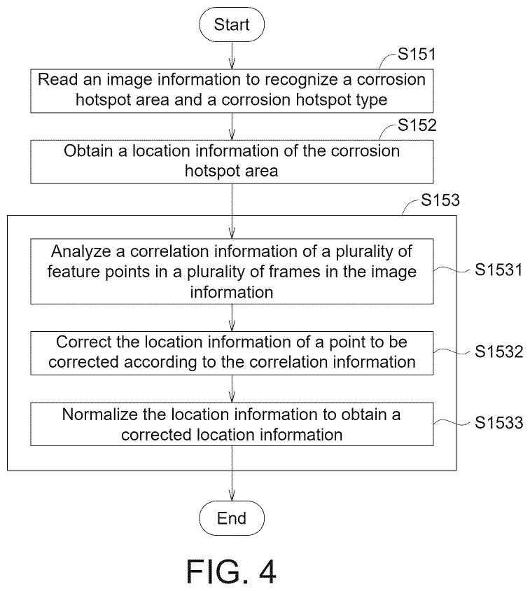

Please refer to FIGS. 3 and 4 at the same time. FIG. 4 illustrates a flow chart of a corrosion positioning method according to an embodiment of the present disclosure. The corrosion positioning method includes step S151 to step S153. The corrosion positioning method of the present disclosure is, for example, performed by the corrosion positioning system 150.

In the step S151, the image information IMi is read with the corrosion hotspot recognition module 151 to recognize the corrosion hotspot area CRij and the corrosion hotspot type TYij thereof. The image information IMi is, for example, captured in real time by the image capturing device 110 installed on the moving platform 140. The image information IMi could be stored in a storage device after shooting, and then retrieved from the storage device. For example, the corrosion hotspot recognition module 151 uses a neural network algorithm to recognize the corrosion hotspot area CRij. The corrosion hotspot type TYij is, for example, flange bolt corrosion, rust bag, floating rust, weld bead corrosion or stainless steel pitting corrosion. The corrosion hotspot area CRij include, for example, the coordinates recorded in the image information IMi (including the vertex and size of the range).

Then, the corrosion hotspot recognition module 151 will send the corrosion hotspot area CRij and the corrosion hotspot type TYij to the inspection optimization module 153, and also send the corrosion hotspot area CRij to the corrosion hotspot positioning module 152.

Next, in the step S152, the corrosion hotspot positioning module 152 obtains the location information LCij of the corrosion hotspot area CRij.

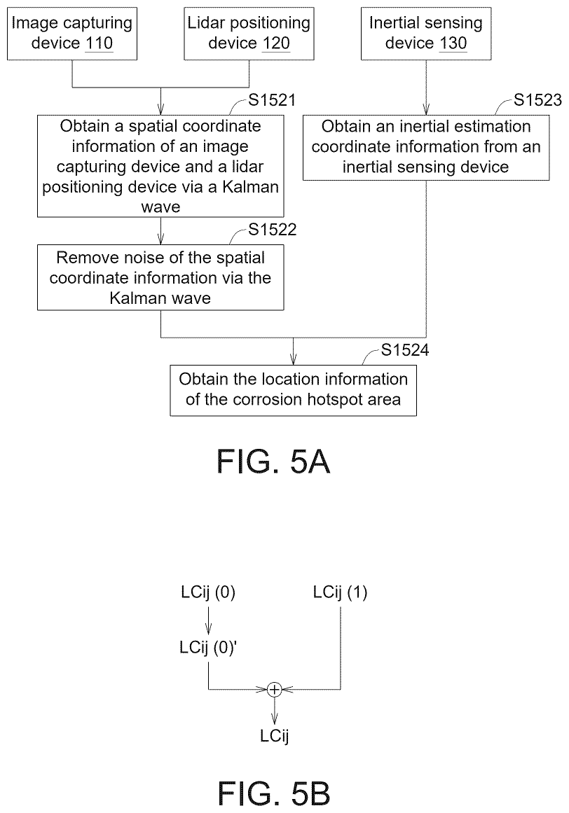

Please refer to FIGS. 5A to 5B. FIG. 5A illustrates a detailed flow chart of the step S152 according to an embodiment of the present disclosure. FIG. 5B illustrates the steps in FIG. 5A. The step S152 of obtaining, by the corrosion hotspot positioning module 151, the location information LCij of the corrosion hotspot area CRij includes step S1521 to step S1524. In the step S1521, the corrosion hotspot positioning module 152 obtains a spatial coordinate information LCij(0) of the image capturing device 110 and the lidar positioning device 120 via a Kalman wave.

Then, in the step S1522, the corrosion hotspot positioning module 152 removes the noise of the spatial coordinate information LCij(0) via the Kalman wave to obtain a spatial coordinate information LCij(0)′ whose noise is removed. The image captured by the image capturing device 110 is easily obscured by clutter in the surrounding environment, and the lidar positioning device 120 will also affect the positioning coordinates of surrounding objects detected by laser light or infrared rays due to light. Therefore, the spatial coordinate information LCij(0) is prone to noise, and this step could filter out the noise from surrounding influencing factors.

Next, in the step S1523, the corrosion hotspot positioning module 152 obtains the inertial estimation coordinate information LCij(1) of the inertial sensing device 130. The inertial sensing device 130 is less susceptible to the influence of light, so it could be used to assist in the positioning of the corrosion hotspot area CRij.

Then, in the step S1524, the corrosion hotspot positioning module 152 obtains the corrected location information LCij of the corrosion hotspot area CRij according to the spatial coordinate information LCij(0)′ whose noise is removed and the inertial estimation coordinate information LCij(1). The inertial estimation coordinate information LCij(1) could be used to compensate the missing part of the spatial coordinate information LCij(0)′. Using the cross comparison of the spatial coordinate information LCij(0)′ and the inertial estimation coordinate information LCij(1), the complete location information LCij of the corrosion hotspot area CRij could be obtained.

Please go back to FIGS. 3 and 4. After obtaining the location information LCij of the corrosion hotspot area CRij in the above step S152, then in step S153 in FIG. 4, the inspection optimization module 153 corrects the location information LCij of the corrosion hotspot area CRij to obtain the corrected location information LCij. The step S153 of correcting the location information LCij of the corrosion hotspot area CRij includes step S1531 to step S1533.

In the step S1531, the correlation analysis unit 1531 of the inspection optimization module 153 analyzes a correlation information RS of a plurality of feature points in a plurality of frames in the image information IMi. In this step, the inspection optimization module 153 uses a memory neural network algorithm to record and encode locations of the feature points, and then uses a Mutual nearest neighbors algorithm to match the feature points in the frames.

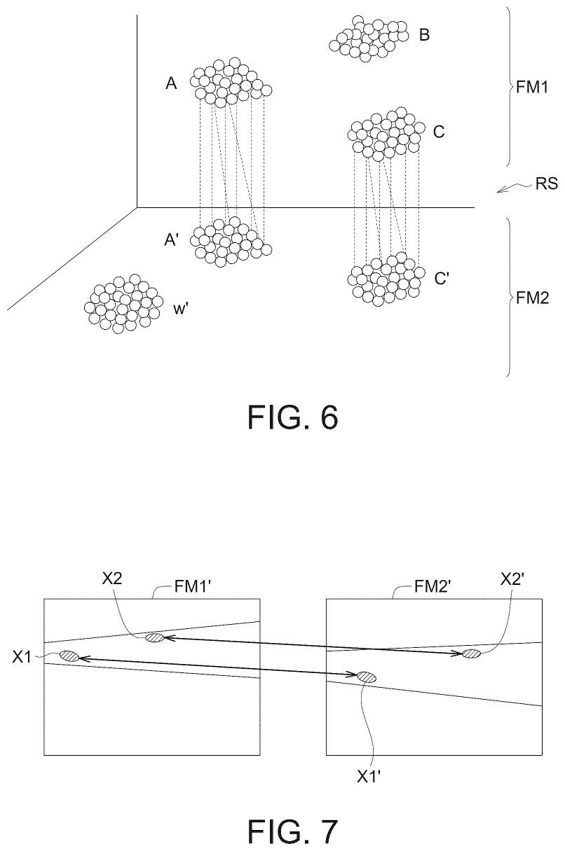

Please refer to FIGS. 6 and 7. FIG. 6 illustrates the mutual nearest neighbor algorithm. FIG. 7 illustrates the matching of the feature points in these images. The mutual nearest neighbor algorithm matches the feature points of similar objects in the two nearest image information IMi to obtain the correlation information RS of these objects. For example, a front image FM1 has a feature point group A, a feature point group B and a feature point group C, and a rear image FM2 has a feature point group A′, a feature point group C′ and a feature point group W′. The memory neural network algorithm will encode according to the correlation of the coordinate positions and the feature points, and the feature point group A and the feature point group C of the front image FM1 will be matched to the feature point group A′ and the feature point group C′ of the rear image FM2 through the mutual nearest neighbor algorithm, to obtain the correlation information RS.

Please referring to FIG. 7, corrosion hotspots X1 and X2 have been recognized in the front image FM1′. When continuously shooting while moving or traveling, the corrosion hotspots X1′ and X2′ will also be recognized in the rear image FM2′. However, due to the influence of light or environment, the location information of the corrosion hotspots X1′ and X2′ may have obvious errors (For example, the Z value may become 0). By using the mutual nearest neighbor algorithm, the feature points in the front image FM1′ and the rear image FM2′ could be matched to obtain the correlation information RS of the corrosion hotspots X1, X2 in the front image FM1′ and the corrosion hotspots X1′, X2′ in the rear image FM2′.

Afterwards, please refer to FIG. 3 and FIG. 4. In the step S1532, the correction unit 1532 of the inspection optimization module 153 corrects the location information LCij of the point to be corrected according to the correlation information RS. The point to be corrected is, for example, the point whose Z value becomes 0.

The following uses Table 1 as an example to illustrate the correction of the location information LCij. For example, in the item “1 Pipe”, the coordinates before the inspection vehicle moving are (147,199,0.850), the coordinates after the inspection vehicle moving are (145,200,0). The Z value of the coordinates after the inspection vehicle moving is 0, so it is the point to be corrected. After the correction unit 1532 performs the correction according to the correlation information RS, the corrected coordinates could be obtained as (146,202,0.88).

TABLE 1

| | Coordinates (x, y, z) | Coordinates (x, y, z) | Corrected |
|---|---|---|---|
| | before the inspection | after the inspection | coordinates |
| item | vehicle moving | vehicle moving | (x, y, z) |
| 1 Pipe | (147, 199, 0.85) | (145, 200, 0) | (146, 202, 0.88) |
| 2 Flang | (58, 218, 0.75) | (64, 218, 0) | (165, 220, 0.77) |
| 3 Pipe | (95, 19, 0) | (96, 20, 1.077) | (96, 20, 0) |
| 4 Flang | (55, 23, 0.92) | (56, 23, 0) | (56, 24, 0.93) |

In the step S1533, the normalization unit 1533 of the inspection optimization module 153 normalizes the location information LCij to obtain the corrected location information LCij*. The normalization unit 1533 of the inspection optimization module 153 normalizes a line coordinate and an angular coordinate of each of the feature points. The normalization unit 1533 normalizes the location information LCij obtained at different times to the same coordinate origin and the same coordinate ratio (for example, normalizing the line coordinates and the angular coordinates) to obtain the corrected location information LCij*.

According to the above various embodiments, the corrosion hotspot area is recognized through the image recognition technology, and the correct location information of the corrosion hotspot area could be obtained through the positioning technology. In addition, the location information of the corrosion hotspot area could be corrected through the optimization technology to improve the accuracy of the inspection and the positioning of the corrosion areas.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A corrosion positioning method, adopted to be built in program codes to be executed by a computer to perform the following steps, comprising:
reading, by a corrosion hotspot recognition module, an image information, to recognize a corrosion hotspot area;
obtaining, by a corrosion hotspot positioning module, a location information of the corrosion hotspot area; and
correcting, by an inspection optimization module, the location information of the corrosion hotspot area, to obtain a corrected location information, wherein the step of correcting the location information of the corrosion hotspot area includes:
analyzing, by the inspection optimization module, a correlation information of a plurality of feature points in a plurality of frames in the image information;
correcting, by the inspection optimization module, the location information of a point to be corrected according to the correlation information; and
normalizing, by the inspection optimization module, the location information, to obtain the corrected location information.

2. The corrosion positioning method according to claim 1, wherein the corrosion hotspot recognition module further reads the image information to recognize a corrosion hotspot type.

3. The corrosion positioning method according to claim 2, wherein the corrosion hotspot type includes flange bolt corrosion, rust bag, floating rust, weld bead corrosion or stainless steel pitting corrosion.

4. The corrosion positioning method according to claim 1, wherein the corrosion hotspot recognition module uses a neural network algorithm to recognize the corrosion hotspot area.

5. The corrosion positioning method according to claim 1, wherein the step of obtaining, by the corrosion hotspot positioning module, the location information of the corrosion hotspot area includes:
obtaining, by the corrosion hotspot positioning module, a spatial coordinate information of an image capturing device and a lidar positioning device via a Kalman wave;
removing, by the corrosion hotspot positioning module, noise of the spatial coordinate information via the Kalman wave;
obtaining, by the corrosion hotspot positioning module, an inertial estimation coordinate information from an inertial sensing device; and
obtaining, by the corrosion hotspot positioning module, the location information of the corrosion hotspot area according to the spatial coordinate information whose noise is removed and the inertial estimation coordinate information.

6. The corrosion positioning method according to claim 1, wherein the step of analyzing, by the inspection optimization module, the correlation information of the feature points in the frames in the image information, the inspection optimization module uses a memory neural network algorithm to record and encode locations of the feature points, and then uses a Mutual nearest neighbors algorithm to match the feature points in the frames.

7. The corrosion positioning method according to claim 1, wherein the step of normalizing, by the inspection optimization module, the location information, the inspection optimization module normalizes a line coordinate and an angular coordinate of each of the feature points.

8. A corrosion positioning system, adopted to be built as a computer, comprising:
a corrosion hotspot recognition module, used to read an image information to recognize a corrosion hotspot area;
a corrosion hotspot positioning module, used to obtain a location information of the corrosion hotspot area; and
an inspection optimization module, used to correct the location information of the corrosion hotspot area to obtain a corrected location information, wherein the inspection optimization module includes:
a correlation analysis unit, used to analyze a correlation information of a plurality of feature points in a plurality of frames in the image information;
a correction unit, used to correct the location information of a point to be corrected according to the correlation information; and
a normalization unit, used to normalize the location information to obtain the corrected location information.

9. The corrosion positioning system according to claim 8, wherein the corrosion hotspot recognition module further reads the image information to recognize a corrosion hotspot type.

10. The corrosion positioning system according to claim 9, wherein the corrosion hotspot type includes flange bolt corrosion, rust bag, floating rust, weld bead corrosion or stainless steel pitting corrosion.

11. The corrosion positioning system according to claim 8, wherein the corrosion hotspot recognition module uses a neural network algorithm to recognize the corrosion hotspot area.

12. The corrosion positioning system according to claim 8, wherein the corrosion hotspot positioning module is connected to an image capturing device, a lidar positioning device and an inertial sensing device; the corrosion hotspot positioning module obtains a spatial coordinate information of the image capturing device and the lidar positioning device via a Kalman wave, and removes noise of the spatial coordinate information via the Kalman wave; the corrosion hotspot positioning module obtains an inertial estimation coordinate information from an inertial sensing device, and the corrosion hotspot positioning module obtains the location information of the corrosion hotspot area according to the spatial coordinate information whose noise is removed and the inertial estimation coordinate information.

13. The corrosion positioning system according to claim 8, wherein the inspection optimization module uses a memory neural network algorithm to record and encode locations of the feature points, and then uses a Mutual nearest neighbors algorithm to match the feature points in the frames.

14. The corrosion positioning system according to claim 8, wherein the inspection optimization module normalizes a line coordinate and an angular coordinate of each of the feature points.

15. A corrosion inspection vehicle, comprising:
a moving platform;
an image capturing device, disposed on the moving platform, wherein the image capturing device is used to capture an image information;
a lidar positioning device, disposed on the moving platform;
a corrosion positioning system, disposed on the moving platform, wherein the corrosion positioning system includes:
a corrosion hotspot recognition module, used to read the image information to recognize a corrosion hotspot area;
a corrosion hotspot positioning module, used to obtain a location information of the corrosion hotspot area; and
an inspection optimization module, used to correct the location information of the corrosion hotspot area to obtain a corrected location information, wherein the inspection optimization module includes:
a correlation analysis unit, used to analyze a correlation information of a plurality of feature points in a plurality of frames in the image information;
a correction unit, used to correct the location information of a point to be corrected according to the correlation information; and
a normalization unit, used to normalize the location information to obtain the corrected location information.

16. The corrosion inspection vehicle according to claim 15, wherein the corrosion hotspot recognition module further reads the image information to recognize a corrosion hotspot type.

17. The corrosion inspection vehicle according to claim 15, wherein the corrosion hotspot recognition module uses a neural network algorithm to recognize the corrosion hotspot area.

18. The corrosion inspection vehicle according to claim 15, wherein the corrosion hotspot positioning module is connected to the image capturing device, the lidar positioning device and an inertial sensing device; the corrosion hotspot positioning module obtains a spatial coordinate information of the image capturing device and the lidar positioning device via a Kalman wave, and removes noise of the spatial coordinate information via the Kalman wave; the corrosion hotspot positioning module obtains an inertial estimation coordinate information from an inertial sensing device, and the corrosion hotspot positioning module obtains the location information of the corrosion hotspot area according to the spatial coordinate information whose noise is removed and the inertial estimation coordinate information.

19. The corrosion inspection vehicle according to claim 15, wherein the inspection optimization module uses a memory neural network algorithm to record and encode locations of the feature points, and then uses a Mutual nearest neighbors algorithm to match the feature points in the frames.

20. The corrosion inspection vehicle according to claim 15, wherein the inspection optimization module normalizes a line coordinate and an angular coordinate of each of the feature points.
